(19) United States
(12) Patent Application Publication
(10) Pub. No.: US 2009/0112833 A1
(43) Pub. Date: Apr. 30, 2009

(54) FEDERATED SEARCH DATA NORMALIZATION FOR RICH PRESENTATION

(76) Inventor: Keith A. Marlow, Galston (AU)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 11/930,000

(22) Filed: Oct. 30, 2007

(51) Int. Cl. G06F 17/30

(52) U.S. Cl. 707/4; 707/E17.014

(57) ABSTRACT

The present invention is directed towards systems and methods for normalizing search engine results page (“SERP”) data. The method of the present invention comprises receiving a search request and retrieving at least one RSS feed in response to receiving said search request. The retrieved RSS feed is normalized and a SERP page is generated based on the at least one RSS feed. The SERP is then provided to a user.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The invention disclosed herein relates generally to normalizing the contents of a search engine results page (“SERP”). More specifically, the present invention is directed towards systems and methods for normalizing data contained within one or more RSS feeds for presentation within a SERP.

### BACKGROUND OF THE INVENTION

Since the advent of the first internet search engines, a plethora of advancements have been made to increase the functionality, usability and commercial viability of individual search engines. One such advancement is the concept of federated searches: the simultaneous searching of separate, and some times disparate, search corpora. The use of federated searching allows a search engine to provide a more comprehensive response to a user query, thus increasing the user satisfaction with the search engine.

The widespread usage of RSS feeds provides a prime data source for federated searching, as fresh information may be constantly provided, guaranteeing the retrieval of relevant data more frequently than traditional data sources. Prior art techniques of incorporating RSS feeds into federated search engines, however, have accepted RSS feeds at face value. That is, the data contained in an RSS feed is simply extracted and displayed to a user via a SERP.

The prior art fails to exploit data present within an RSS feed to generate a comprehensive representation of a given feed. For example, a contact feed containing a name, address and phone number may simply be displayed to the user via a SERP using standard HTML, CSS and JavaScript components. Additionally, a map RSS feed may comprise a location name and a set of latitude and longitude coordinates, wherein a SERP may identify the location on a map. In this example, there is little overlap between the two RSS feeds, thus they are represented in an obvious and straightforward manner that fails to appreciate or take into account any relationships between disparate feeds.

The present invention cures this deficiency by normalizing RSS feeds to form a complete representation of a plurality of RSS feeds. Continuing the previous example, a location field from a contact RSS feed may be utilized to form a geocoded set of coordinates that allow the contact to be identified on a map. Thus, the present invention provides systems, methods and computer program products for normalizing RSS data and providing a more complete representation of data, thereby allowing for the exposure and identification of data relationships between feeds.

### SUMMARY OF THE INVENTION

The present invention is directed towards systems and methods for normalizing SERP data. The method of the present invention comprises receiving a search request. In one embodiment, a search request may comprise an HTTP request.

In response to a given search request, at least on RSS feed may be retrieved. In one embodiment, retrieving at least one RSS feed comprises extracting a search query from said search request. In an alternative embodiment, retrieving at least one RSS feed comprises retrieving an RSS feed from a remote location. In one embodiment, a remote location comprises a search database.

A given retrieved RSS feed is then normalized. In one embodiment, normalizing comprises reformatting existing RSS feed data. In an alternative embodiment, normalizing a given RSS feed comprises generating new RSS data based on the retrieved RSS data. The present embodiment may then further generate a map position based on address data.

A SERP is then generated, the SERP based on at least one normalized RSS feed and the SERP is provided to a user. In a first embodiment, generating a SERP comprises embedding said normalized RSS feed within a resource. In an alternative embodiment, generating a SERP comprises executing a search in response to said normalized RSS feed. The search results may then be embedded the SERP.

The present invention is further directed towards a system for normalizing SERP data. The system of the present invention comprises a plurality of client devices coupled to a network and a content provider coupled to the network. In one embodiment the content provider comprises a content server operative to receive search requests from said client devices and transmit SERP data to said client devices. In a first embodiment, a search request comprises an HTTP request.

A content provider may further comprise an aggregator operative to retrieve at least one RSS feed in response to receiving said search request. In a first embodiment, retrieving at least one RSS feed comprises extracting a search query from said search request. In an alternative embodiment, retrieving at least one RSS feed comprises retrieving an RSS feed from a remote location. In one embodiment, a remote location comprises a search database.

The system further comprises a normalization module operative to normalize said at least one RSS feed. In one embodiment, normalizing comprises re-formatting existing RSS feed data. In a first embodiment, the system may comprise a data retrieval module operative to generate new RSS data based on the retrieved RSS data. In an alternative embodiment, data retrieval module may further be operative to generate a map position based on address data.

The content provider further comprises a presentation module operative to generate a SERP based on the at least one normalized RSS feed. In a first embodiment, generating a SERP comprises embedding said normalized RSS feed within a resource. In an alternative embodiment, generating a SERP comprises executing a search in response to said normalized RSS feed. The search results may then be embedded the SERP.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 presents a block diagram illustrating a system for normalizing RSS feeds for presentation within a SERP according to one embodiment of the present invention;

FIG. 2 presents a flow diagram illustrating a method for normalizing search result RSS feeds according to one embodiment of the present invention;

FIG. 3 presents a flow diagram illustrating a method for normalizing a given RSS feed according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

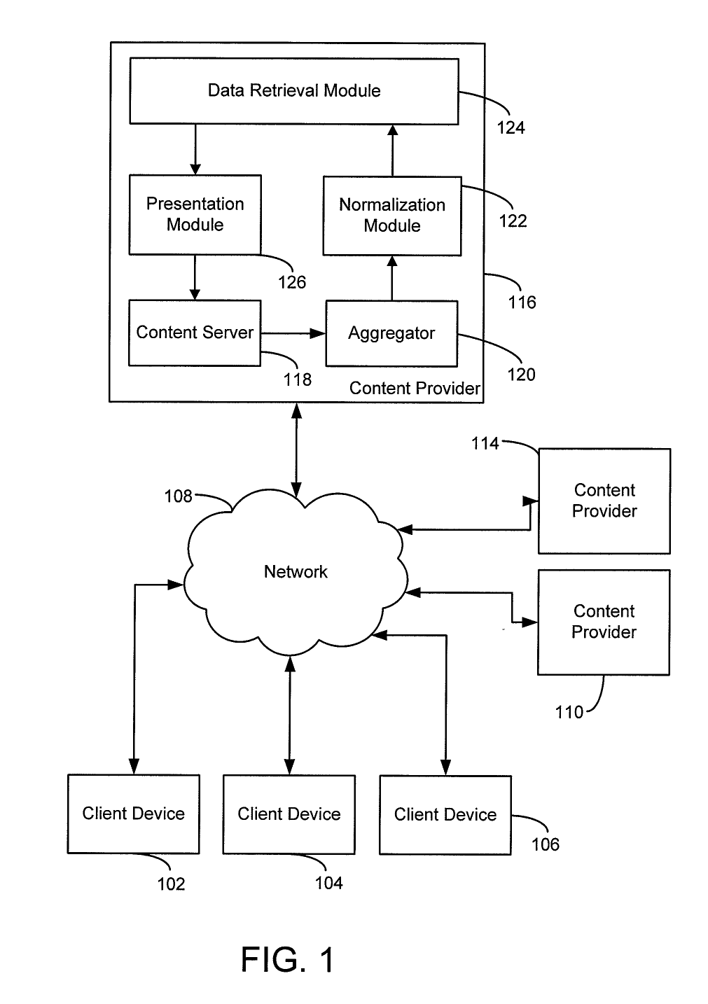

FIG. 1 presents a block diagram illustrating one embodiment of a system for normalizing RSS feeds for presentation within a SERP. According to the embodiment that FIG. 1 illustrates, a plurality of client devices 102, 104 and 106 are communicatively coupled to a network 108, which may include a connection to one or more local and wide area networks, such as the Internet. According to one embodiment of the invention, a given client device 102, 104 and 106 is a general-purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A given client device 102, 104 and 106 is in communication with a content provider 116 that hosts a plurality of content items. Content provider 116 comprises a content server 118 operative to receive requests for data from a given client device 102, 104 and 106. In one embodiment, a request may comprise an HTTP request for content submitted by a client device 102, 104 and 106 through a browser application or similar device. Content provider 116 is further coupled to a plurality of content providers 110 and 114. Content providers 110 and 114 are operative to transmit data to content provider 116. In one embodiment, content providers 110 and 114 provide RSS feeds to content provider 116.

According to the present embodiment, content server 118 receives a request for a SERP from a given client device 102, 104 and 106 and parses a query string received with the SERP request. In one embodiment, a SERP page may comprise a customizable federated search results page. That is, a user may be able to determine which sources are utilized in generating the final federated SERP. In response to parsing a query string, content server 118 transmits the query string data to aggregator 120. Aggregator 120 is operative to fetch a plurality of RSS feeds in response to the user entered query string. In one embodiment, aggregator 120 may fetch at least one RSS feed from a given content provider 110, 114.

A given content provider 110, 114 may publish a plurality of feeds summarizing content of a given provider 110, 114. For example, a financial content provider may provide a feed in response to a user query indicating a company name, stock price and company information; a weather content provider may provide a feed comprising a location name, current weather conditions or radar data. Aggregator 120 collects a plurality of data from various feeds and transmits the feed data to normalization module 122.

Normalization module 122 is operative to analyze a given received feed and normalize a feed according to a predetermined feed normalization template. For example, a normalization template may comprise normalizing a given feed to contain a location coordinate (latitude, longitude), data name (company name, location name, etc.), data description (company info, location details), URL, free text field, e-mail address, date and time, etc. although alternative embodiments may exist wherein a normalization template comprises additional fields. In an alternative embodiment, normalization module 122 may be operative to extract data from the RSS feed and normalize the feed in response to the extraction. For example, a free text field may comprise text data comprising phone numbers, e-mail addresses etc. The normalization module 122 may be operative to parse the free text data and populate the normalization template in response to the detection of the presence of template field matches.

Normalization module 120 normalizes a given RSS feed by analyzing the content of an RSS feed and dynamically extracting template data from the given RSS data. Continuing the previous example, a company RSS feed comprising only a company name may be normalized to generate a location field, address, phone number, stock quote, e-mail address, company website etc. In this example, a helper application may search for the company name in a location database may be executed to locate the geographical address. The returned geographical address may then be geocoded to determine a set of coordinates for a given company name and stored within a normalized RSS feed.

A given normalized RSS feed is then transmitted to data retrieval module 124. Data retrieval module 124 is operative to extract data from a normalized RSS feed and retrieve associated data with the RSS feed. For example, a normalized RSS feed may comprise a location coordinate field comprising a latitude and longitude coordinate. Data retrieval module 124 may retrieve map data corresponding to the given coordinate, such as a map image corresponding to the given location. In an alternative example, a normalized RSS feed may comprise a company name wherein additional company details (such as a company description) may be retrieved by data retrieval module 124.

In one embodiment, the SERP may comprise a federated SERP allowing a user to select the federated sources for display. A user may be able to customize the display of search results on the basis of data the user is seeking. For example, a user may enter a query for a publication and search the federated search engine for said publication. Embodiments of the present invention may search across a plurality of library, publication and periodical databases returning a multitude of matches to the user query. A normalization module 122 may be operative to parse each returned publication and determine locations where the article was authored, subject matter or a plurality of related data stored within a normalization template. This normalization allows a SERP to present a list of relevant matches, a list of relevant subjects and the locations of where each was publish on a map to provide a more comprehensive result set as compared with current search techniques. For example, a user may determine how many publications on a given subject have been published at a given university using the components of the federated SERP.

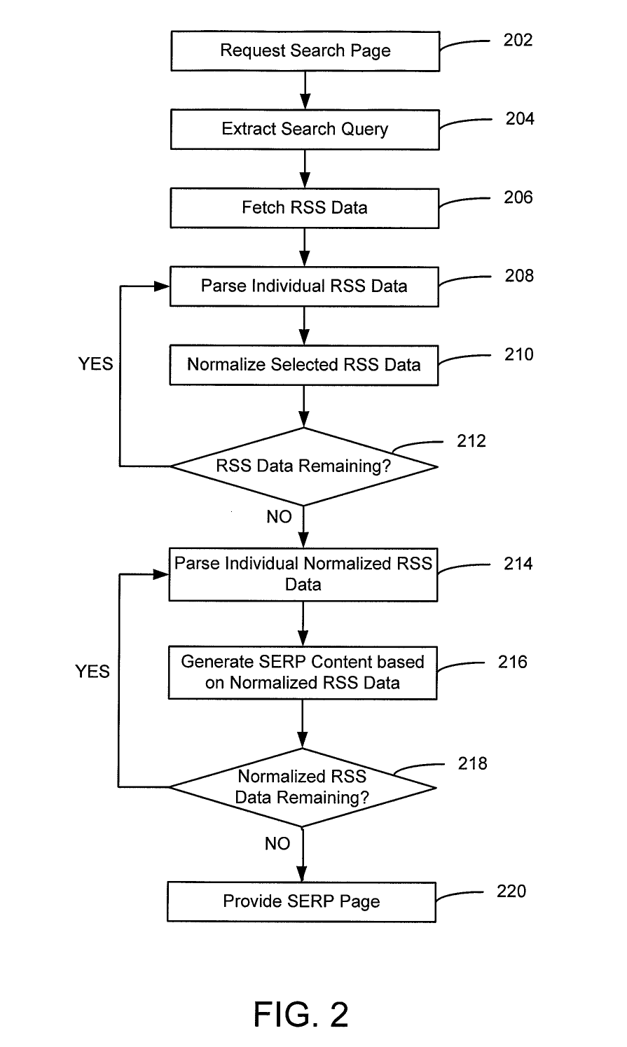

The SERP data is then transmitted to presentation module 126, presentation module 126 operative to format the data according to a predetermined template. According to the illustrated embodiment, presentation module 126 may be operative to organize the received data in a final presentation format displayed to a user within a browser. In one embodiment, a presentation module may generate a document comprising HTML, CSS, JavaScript code, etc. The resulting SERP document is then provided to content server 118, which in turn transmits the SERP document to a given client device 102, 104, 106 via network 108. FIG. 2 provides a flow diagram illustrating a method for normalizing search result RSS feeds according to one embodiment of the present invention. As FIG.2 illustrates, a method 200 receives a request for a search results page, step 202. In one embodiment, a request may comprise an HTTP request submitted by a user via an HTML form.

The method 200 then extracts the search query from a given search request, step 204. In one embodiment, a search query may comprise a character string embedded within an HTTP search request, such as within header information stored within the request. In response to extracting a search query, the method 200 fetches RSS data corresponding to user search query, step 206. In one embodiment, the method 200 uses the extracted search query to generate an RSS feed request. For example, an extracted user search query may be propagated and modified to generate a plurality of RSS feed requests from predefined RSS feed sources. According to one embodiment, a returned RSS feed may comprise an XML formatted document comprising a plurality of data fields comprising information related to the query response.

A given RSS feed fetched in step 206 is then parsed, step 208. In one embodiment, parsing an RSS feed comprises extracting predefined data from an RSS feed. For example, a given RSS feed may be parsed to extract address data from a given RSS feed. The extracted data is then normalized, step 210. In one embodiment, normalization may comprise formatting a given RSS feed to fit a predetermined RSS template. For example, a normalized RSS template may comprise a URL, free text field, e-mail address, date and time, location coordinate field (latitude and longitude), telephone number, e-mail address, etc. Continuing the previous example, address data from a given RSS field may be geocoded and a location coordinate may be generated and inserted into the normalized RSS feed template. Additionally, helper application may be called to generate additional template fields not found within the given RSS feed. For example, a helper application may use the name of a company within an RSS feed to generate or otherwise retrieve a phone number and e-mail address for the company. Although only one example of a normalized template field is presented, it is understood that a plurality of other fields may be implemented within a normalized RSS template.

Method 200 checks to determine if one or more of the received RSS data feeds have been normalized, step 212. If not, the remaining feeds are normalized, steps 208, 210. If so, the normalized feeds are utilized to generate a SERP, steps 214, 216, 218 and 220.

The method 200 parses a given normalized RSS feed, step 214, and generates SERP content based on the normalized RSS data, step 216. According to the illustrated embodiment, parsing normalized RSS data may comprise extract data from a given XML formatted RSS feed. In alternative embodiment, parsing normalized RSS data may further comprise performing a secondary search using the normalized RSS field data. For example, a RSS data field may comprise a given location coordinate, wherein parsing the RSS data field may involve retrieving information related to a given location coordinate, such as map information, position, etc.

Following the parsing of a given normalized RSS feed, SERP content is generated based upon the parsed data, step 216. According to the illustrated embodiment, generating SERP content may comprise a plurality of HTML, CSS or JavaScript components operative to display the parsed data. In an alternative embodiment, SERP content may comprise program code operable to retrieve additional SERP content upon receipt at a given client device, commonly known as asynchronous retrieval.

The method 200 monitors the generation of SERP content and checks to ensure that the normalized RSS data has been parsed, step 218. If normalized RSS data remains, the remaining normalized RSS data feeds are parsed, steps 214, 216. If there are no normalized RSS data feeds remaining to be parsed, the final SERP page is provided, step 220.

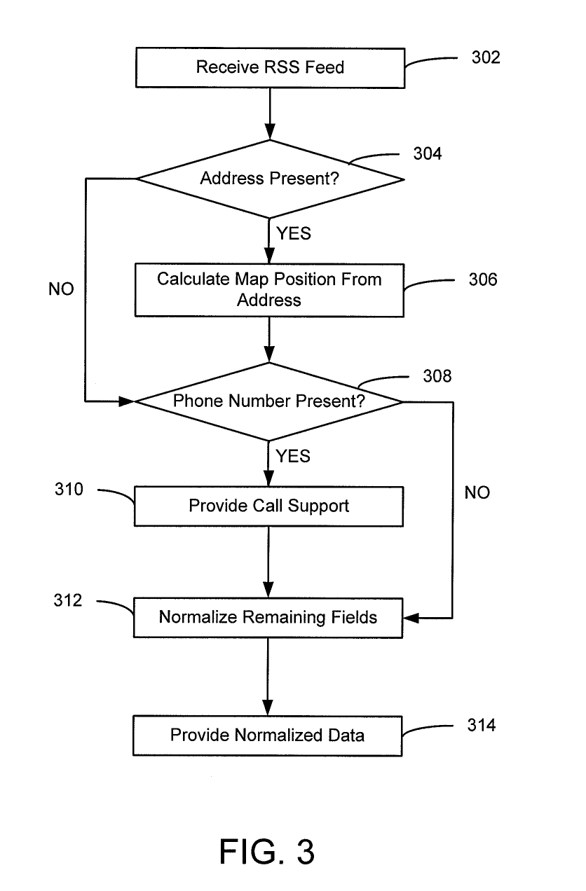

FIG. 3 provides a flow diagram illustrating a method for normalizing a given RSS feed according to one embodiment of the present invention. As FIG. 3 illustrates, a method 300 receives a given RSS feed, step 302. As previously described, a given RSS feed may be retrieved via an HTTP request to a remote content provider. A given RSS comprises an XML compliant document adhering to a predefined specification.

The method 300 then performs a plurality of normalizing operations including normalizing address data (steps 304, 306) and normalizing call support (steps 308, 310). Although only two specific normalization parameters are illustrated, alternative embodiment may utilize various other parameters in conjunction or in place of the foregoing.

The illustrated method 300 determines if address data is present within a given RSS feed, step 304. As previously discussed, address data may comprise a physical address such as “123 Main St. New York, N.Y.”. If an address is present, a map position is calculated for a given address, step 306. In one embodiment, a map position may be calculated using a remote geocoding service that translates physical addresses to latitude and longitude coordinates. For example, a first RSS feed may comprise an element:

<address>123 Main St. New York, NY</address>

### EXAMPLE 1

and a second RSS feed may comprise an element:

<street>123 Main Street</street>
<city>New York</city>
<state>New York</state>

### EXAMPLE 2

As can be seen in Examples 1 and 2, the same address is represented in two substantially different ways between two RSS feeds. In this embodiment, calculating a map position may comprise extracting the data from the RSS feed. In one embodiment, extracting an address may comprise extracting data based on previous knowledge of the RSS feed. That is, the method 300 is informed of the structure of the XML comprising a given RSS feed and extracts the data based on the knowledge of the RSS feed structure. In an alternative embodiment, extracting an address may comprise scanning an RSS feed to detect the presence of an address and extracting the address in response to a regular expression match. After extracting a given address, the address is geocoded and a latitude and longitude may be written a new, normalized RSS feed.

If an address if not present, or after an address has been geocoded, the method 300 checks to see whether a phone number is present within a given RSS feed, step 308. Similar to steps 304 and 306, if a phone number is present, call support is provided in a normalized RSS feed, step 310. For example, a normalized RSS feed may comprise a plurality of parameters enabling call support during the generation of a SERP.

If a phone number is not present or if call support has been provided to the normalized RSS feed, the remaining fields are normalized, step 312, and the normalized RSS data is provided, step 314. As previously mentioned, a normalization template may comprise a plurality of normalization factors, factors including the previously mentioned address and phone number fields. For example, a normalization template may be operative to extract a stock ticker symbol from a given RSS feed containing a company name.

FIGS. 1 through 3 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A method for normalizing search engine results page (“SERP”) data, the method comprising:
receiving a search request from a user;
retrieving at least one RSS feed in response to receiving the search request;
normalizing the at least one RSS feed;
generating a SERP on the basis of the at least one normalized RSS feed; and
providing the SERP to the user.

2. The method of claim 1 wherein retrieving the at least one RSS feed comprises extracting a search query from the search request.

3. The method of claim 1 wherein retrieving the at least one RSS feed comprises retrieving an RSS feed from a remote location.

4. The method of claim 1 wherein normalizing comprises re-formatting data comprising the at least one RSS feed.

5. The method of claim 1 wherein normalizing comprises generating new RSS data on the basis of the retrieved RSS feed.

6. The method of claim 1 wherein generating the SERP comprises embedding the normalized RSS feed within a resource.

7. The method of claim 1 wherein generating a SERP comprises executing a search in response to the normalized RSS feed.

8. The method of claim 7 comprising embedding a plurality of search results within the SERP.

9. A system for normalizing search engine results page (“SERP”) data, the system comprising:
a plurality of client devices coupled to a network; and
a content provider coupled to said network, the content provider comprising:
a content server operative to receive search requests from a given client devices and transmit the SERP data to said client devices;
an aggregator operative to retrieve at least one RSS feed in response to receiving a given search request;
a normalization module operative to normalize the at least one RSS feed; and
a presentation module operative to generate a SERP on the basis of the at least one normalized RSS feed.

10. The system of claim 9 wherein the at least one RSS feed comprises a search query from the search request.

11. The system of claim 9 wherein the at least one RSS feed is retrieved from a remote location.

12. The system of claim 9 wherein the normalization module re-formats existing RSS feed data.

13. The system of claim 9 comprising a data retrieval module operative to generate new RSS data based on the retrieved RSS data.

14. The system of claim 9 wherein the normalized RSS feed is embedded within a resource.

15. The system of claim 14 wherein the presentation module embeds a plurality of search results within the SERP.

16. Computer readable media comprising program code for execution by a programmable processor that instructs the processor to perform a method for normalizing search engine results page (“SERP”) data, the method comprising:
program code for receiving a search request from a user;
program code for retrieving at least one RSS feed in response to receiving the search request;
program code for normalizing the at least one RSS feed;
program code for generating a SERP on the basis of the at least one normalized RSS feed; and
program code for providing the SERP to the user.

17. The computer readable media of claim 16 wherein the program code for retrieving the at least one RSS feed comprises program code for extracting a search query from the search request.

18. The computer readable media of claim 16 wherein the program code for retrieving the at least one RSS feed comprises program code for retrieving an RSS feed from a remote location.

19. The computer readable media of claim 16 wherein the program code for normalizing comprises program code for re-formatting data comprising the at least one RSS feed.

20. The computer readable media of claim 16 wherein the program code for normalizing comprises program code for generating new RSS data on the basis of the retrieved RSS feed.

21. The computer readable media of claim 16 wherein the program code for generating the SERP comprises program code for embedding the normalized RSS feed within a resource.

22. The computer readable media of claim 16 wherein the program code for generating a SERP comprises program code for executing a search in response to the normalized RSS feed.

23. The computer readable media of claim 22 comprising program code for embedding a plurality of search results within the SERP.
